(19) United States
(12) Patent Application Publication
(10) Pub. No.: US 2026/0038439 A1
(43) Pub. Date: Feb. 5, 2026

(54) PIXEL, DISPLAY APPARATUS INCLUDING THE SAME AND ELECTRONIC APPARATUS INCLUDING THE SAME

(71) Applicant: Samsung Display Co., Ltd., Yongin-si (KR)

(72) Inventor: JUNHYUN PARK, Yongin-si (KR)

(21) Appl. No.: 19/281,175

(22) Filed: Jul. 25, 2025

(30) Foreign Application Priority Data
Jul. 30, 2024 (KR) 10-2024-0101194
Mar. 7, 2025 (KR) 10-2025-0029408

(51) Int. Cl. G09G 3/3233

(52) U.S. Cl. CPC G09G 3/3233; G09G 2310/08

(57) ABSTRACT

A pixel includes a light emitting element, a first transistor, a second transistor, a third transistor, and a fourth transistor. The first transistor includes a control electrode connected to a first node, a first electrode connected to a second node, and a second electrode connected to an anode electrode of the light emitting element. The second transistor includes a control electrode to receive a first gate signal, a first electrode to receive a data voltage, and a second electrode connected to the second node. The third transistor includes a control electrode to receive a second gate signal, a first electrode connected to the first node, and a second electrode connected to the anode electrode of the light emitting element. The fourth transistor includes a control electrode to receive an emission signal, a first electrode to receive a first power voltage, and a second electrode connected to the second node.

### CROSS-REFERENCE TO RELATED APPLICATION

This application claims priority to and the benefit of Korean Patent Application No. 10-2024-0101194, filed on Jul. 30, 2024, and Korean Patent Application No. 10-2025-0029408, filed on Mar. 7, 2025, in the Korean Intellectual Property Office, the entire disclosures of which are incorporated by reference herein.

### BACKGROUND

### 1. Field

The present disclosure relates to a pixel, a display apparatus including the pixel and an electronic apparatus including the pixel. More particularly, the present disclosure relate to a pixel applicable to a high resolution display apparatus, a display apparatus including the pixel and an electronic apparatus including the pixel.

### 2. Description of the Related Art

Generally, a display apparatus includes a display panel and a display panel driver. The display panel includes a plurality of gate lines, a plurality of data lines, a plurality of emission lines, and a plurality of pixels. The display panel driver includes a gate driver, a data driver, an emission driver, and a driving controller. The gate driver outputs gate signals to the gate lines. The data driver outputs data voltages to the data lines. The emission driver outputs emission signals to the emission lines. The driving controller controls the gate driver, the data driver, and the emission driver.

When the data voltage is written to the pixel by capacitance distribution between two capacitors, process deviations of the capacitors may affect a display quality of the display panel.

### SUMMARY

Embodiments of the present disclosure provide a pixel to which a data voltage is written without capacitance distribution, accordingly, having a reduced influence of process deviations of capacitors and capable of enhancing a display quality.

Embodiments of the present disclosure provide a display apparatus including the pixel.

Embodiments of the present disclosure provide an electronic apparatus including the pixel.

According to one or more embodiments of the present disclosure, a pixel includes a light emitting element, a first transistor, a second transistor, a third transistor and a fourth transistor. The first transistor includes a control electrode connected to a first node, a first electrode connected to a second node and a second electrode connected to an anode electrode of the light emitting element. The second transistor includes a control electrode configured to receive a first gate signal, a first electrode configured to receive a data voltage and a second electrode connected to the second node. The third transistor includes a control electrode configured to receive a second gate signal, a first electrode connected to the first node and a second electrode connected to the anode electrode of the light emitting element. The fourth transistor includes a control electrode configured to receive an emission signal, a first electrode configured to receive a first power voltage and a second electrode connected to the second node.

In one or more embodiments, the pixel may further include a first capacitor including a first electrode configured to receive a first voltage and a second electrode connected to the first node.

In one or more embodiments, the pixel may further include a second capacitor including a first electrode configured to receive the first power voltage and a second electrode connected to the second node.

In one or more embodiments, the first power voltage may have a high level in a first period of a driving timing of the pixel. A second power voltage applied to a cathode electrode of the light emitting element may have a high level in the first period. The emission signal may have an active level in the first period. The first gate signal may have an inactive level in the first period. The second gate signal may have an inactive level in the first period. The first voltage may have a low level in the first period.

In one or more embodiments, the first power voltage may have a low level in a second period subsequent to the first period. The second power voltage may have the high level in the second period. The emission signal may have the active level in the second period. The first gate signal may have the inactive level in the second period. The second gate signal may have the inactive level in the second period. The first voltage may sequentially have a high level and the low level in the second period.

In one or more embodiments, the first power voltage may have the low level in a third period subsequent to the second period. The second power voltage may have the high level in the third period. The emission signal may have an inactive level in the third period. The first gate signal may have an active level in the third period. The second gate signal may have an active level in the third period. The first voltage may sequentially have the low level and the high level in the third period.

In one or more embodiments, the first power voltage may have the low level in a fourth period subsequent to the third period. The second power voltage may have the high level in the fourth period. The emission signal may have the inactive level in the fourth period. The first gate signal may have at least one active pulse in the fourth period. The second gate signal may have at least one active pulse in the fourth period. The first voltage may have the high level in the fourth period.

In one or more embodiments, the first power voltage may have the low level in a fifth period subsequent to the fourth period. The second power voltage may sequentially have the high level and the low level in the fifth period. The emission signal may have the active level in the fifth period. The first gate signal may have the inactive level in the fifth period. The second gate signal may have the inactive level in the fifth period. The first voltage may have the low level in the fifth period.

In one or more embodiments, the first power voltage may have the high level in a sixth period subsequent to the fifth period. The second power voltage may have the low level in the sixth period. The emission signal may have the active level in the sixth period. The first gate signal may have the inactive level in the sixth period. The second gate signal may have the inactive level in the sixth period. The first voltage may have the high level in the sixth period.

In one or more embodiments, the first power voltage may have a low level in a second period subsequent to the first period. The second power voltage may have the high level in the second period. The emission signal may have the active level in the second period. The first gate signal may have the inactive level in the second period. The second gate signal may have the inactive level in the second period. The first voltage may have the low level in the second period. The first power voltage may have the low level in a third period subsequent to the second period. The second power voltage may have the high level in the third period. The emission signal may have an inactive level in the third period. The first gate signal may have an active level in the third period. The second gate signal may have an active level in the third period. The first voltage may sequentially have the low level and the high level in the third period.

In one or more embodiments, the first transistor may further include a second control electrode configured to receive the first voltage.

In one or more embodiments, the first transistor may further include a second control electrode configured to receive a second voltage that is different from the first voltage, the first power voltage, and a second power voltage applied to a cathode electrode of the light emitting element.

In one or more embodiments, the first transistor may further include a second control electrode configured to receive the first power voltage.

In one or more embodiments, the first transistor may further include a second control electrode configured to receive a second power voltage applied to a cathode electrode of the light emitting element.

In one or more embodiments, the first gate signal may be an N-th gate signal. The second gate signal may be an N+1-th gate signal. N is a positive integer. The first gate signal and the second gate signal may be generated by a same driver.

In one or more embodiments, the first gate signal and the second gate signal may have substantially a same waveform in a first period, a second period and a third period of a driving timing of the pixel. The first gate signal and the second gate signal may have progressive waveforms in a fourth period of the driving timing of the pixel subsequent to the third period of the driving timing of the pixel.

In one or more embodiments, an active pulse of the first gate signal and an active pulse of the second gate signal may be partially overlapped.

In one or more embodiments, the first transistor and the fourth transistor may be P-type transistors. The second transistor and the third transistor may be N-type transistors.

In one or more embodiments, a display apparatus includes a display panel, a gate driver, a data driver and an emission driver. The display panel includes a pixel. The gate driver is configured to output a first gate signal and a second gate signal to the pixel. The data driver is configured to output a data voltage to the pixel. The emission driver is configured to output an emission signal to the pixel. The pixel includes a light emitting element, a first transistor, a second transistor, a third transistor and a fourth transistor. The first transistor includes a control electrode connected to a first node, a first electrode connected to a second node and a second electrode connected to an anode electrode of the light emitting element. The second transistor includes a control electrode configured to receive the first gate signal, a first electrode configured to receive the data voltage and a second electrode connected to the second node. The third transistor includes a control electrode configured to receive the second gate signal, a first electrode connected to the first node and a second electrode connected to the anode electrode of the light emitting element. The fourth transistor includes a control electrode configured to receive an emission signal, a first electrode configured to receive a first power voltage and a second electrode connected to the second node.

In one or more embodiments, an electronic apparatus includes a display panel, a gate driver, a data driver, an emission driver, a driving controller and a processor. The display panel includes a pixel. The gate driver is configured to output a first gate signal and a second gate signal to the pixel. The data driver is configured to output a data voltage to the pixel. The emission driver is configured to output an emission signal to the pixel. The driving controller is configured to control the gate driver, the data driver and the emission driver. The processor is configured to output input image data and an input control signal to the driving controller. The pixel includes a light emitting element, a first transistor, a second transistor, a third transistor and a fourth transistor. The first transistor includes a control electrode connected to a first node, a first electrode connected to a second node and a second electrode connected to an anode electrode of the light emitting element. The second transistor includes a control electrode configured to receive the first gate signal, a first electrode configured to receive the data voltage and a second electrode connected to the second node. The third transistor includes a control electrode configured to receive the second gate signal, a first electrode connected to the first node and a second electrode connected to the anode electrode of the light emitting element. The fourth transistor includes a control electrode configured to receive an emission signal, a first electrode configured to receive a first power voltage and a second electrode connected to the second node.

According to one or more embodiments, the pixel, the display apparatus including the pixel, and the electronic apparatus including the pixel, the data voltage may be written to the pixel without capacitance distribution so that an influence of process deviations of the capacitors may be reduced, and accordingly, a display quality of the display panel may be enhanced.

In addition, the first gate signal applied to the second transistor and the second gate signal applied to the third transistor may be generated by the same driver so that an area occupied by the gate driver may be reduced and a manufacturing cost of the display apparatus may be reduced.

In addition, the pixel may include four transistors and two capacitors. The pixel includes a relatively small number of transistors and a relatively small number of capacitors so that the pixel may be applied to a high-resolution display apparatus.

### BRIEF DESCRIPTION OF THE DRAWINGS

The above and other aspects and features of the present disclosure will become more apparent by describing in detailed embodiments thereof with reference to the accompanying drawings, in which:

FIG. 1 is a block diagram illustrating a display apparatus according to one or more embodiments of the present disclosure;

FIG. 2 is a circuit diagram illustrating a pixel of a display panel of FIG. 1;

FIG. 3 is a timing diagram illustrating an example of input signals applied to the pixel of FIG. 2;

FIG. 4 is a timing diagram illustrating an example of input signals applied to the pixel of FIG. 2;

FIG. 5 is a circuit diagram illustrating a pixel of a display panel of a display apparatus according to one or more embodiments of the present disclosure;

FIG. 6 is a circuit diagram illustrating a pixel of a display panel of a display apparatus according to one or more embodiments of the present disclosure;

FIG. 7 is a circuit diagram illustrating a pixel of a display panel of a display apparatus according to one or more embodiments of the present disclosure;

FIG. 8 is a circuit diagram illustrating a pixel of a display panel of a display apparatus according to one or more embodiments of the present disclosure;

FIG. 9 is a block diagram illustrating an electronic apparatus according to one or more embodiments of the present disclosure;

FIG. 10 is a diagram illustrating an example in which the electronic apparatus of FIG. 9 is implemented as a virtual reality display system;

FIG. 11 is a diagram illustrating an example in which the electronic apparatus of FIG. 9 is implemented as a smart phone;

FIG. 12 is a block diagram illustrating an electronic apparatus according to one or more embodiments of the present disclosure; and

FIG. 13 is a diagram illustrating examples of the electronic apparatus of FIG. 12.

### DETAILED DESCRIPTION

In the specification, the expression that a first component (or area, layer, part, portion, etc.) is “disposed on”, “connected with” or “coupled to” a second component means that the first component is directly disposed on/connected with/coupled to the second component or means that a third component is interposed therebetween.

The same reference numerals refer to the same components. Further, in the drawings, the thickness, the ratio, and the dimension of components are exaggerated for effective description of technical contents. The expression “and/or” includes one or more combinations which associated components are capable of defining.

Although the terms “first”, “second”, etc. may be used to describe various components, the components should not be limited by the terms. The terms are only used to distinguish one component from another component. For example, without departing from the right scope of the present disclosure, a first component may be referred to as a second component, and similarly, the second component may be also referred to as the first component. Singular expressions include plural expressions unless clearly otherwise indicated in the context.

Also, the terms “under”, “below”, “on”, “above”, etc. are used to describe the correlation of components illustrated in drawings. The terms that are relative in concept are described based on a direction illustrated in drawings.

It will be understood that the terms “include”, “comprise”, “have”, etc. specify the presence of features, numbers, steps, operations, elements, or components, described in the specification, or a combination thereof, and do not exclude in advance the presence or additional possibility of one or more other features, numbers, steps, operations, elements, or components or a combination thereof.

Terms “part” and “unit” mean a software component or hardware component that performs a specific function. The hardware component may include, for example, a field-programmable gate array (FPGA) or an application-specific integrated circuit (ASIC). The software component may refer to an executable code and/or data used by the executable code in an addressable storage medium. Thus, the software components may be, for example, object-oriented software components, class components, and task components, and may include processes, functions, attributes, procedures, subroutines, program code segments, drivers, firmwares, microcodes, circuits, data, database, data structures, tables, arrays, or variables.

Unless otherwise defined, all terms (including technical terms and scientific terms) used in the specification have the same meaning as commonly understood by those skilled in the art to which the present disclosure belongs. Further, terms such as terms defined in the dictionaries commonly used should be interpreted as having a meaning consistent with the meaning in the context of the related technology and should not be interpreted in overly ideal or overly formal meanings unless explicitly defined herein.

For the purposes of the present disclosure, expressions such as “at least one of,” “one of,” and “selected from,” when preceding a list of elements, modify the entire list of elements and do not modify the individual elements of the list. For example, “at least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, XZ, YZ, and ZZ, or any variation thereof. Similarly, the expression such as “at least one of A and/or B” may include A, B, or A and B. As used herein, the term “and/or” includes any and all combinations of one or more of the associated listed items. For example, the expression such as “A and/or B” may include A, B, or A and B. Further, the use of “may” when describing embodiments of the present disclosure refers to “one or more embodiments of the present disclosure”.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, the present disclosure will be discussed in detail with reference to the accompanying drawings.

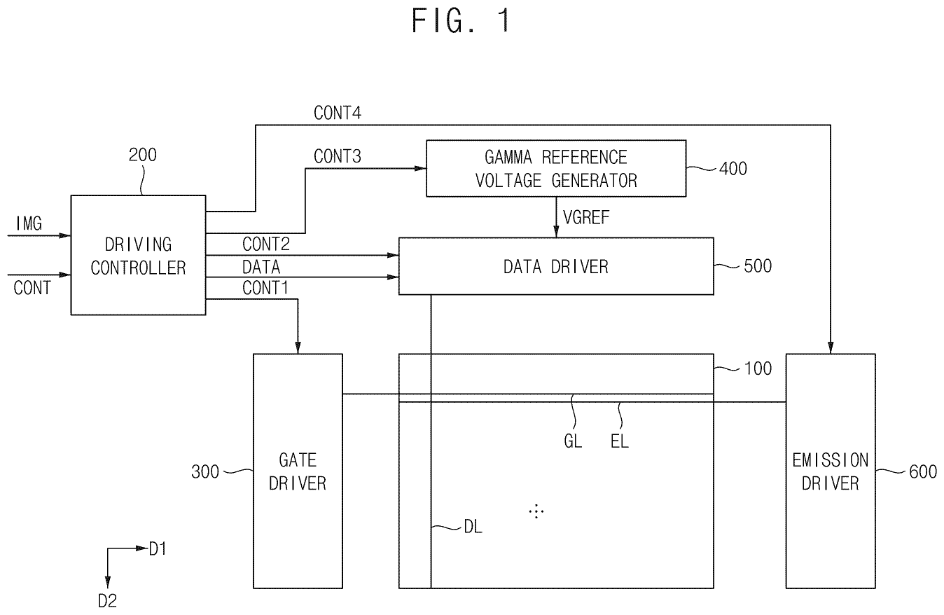

FIG. 1 is a block diagram illustrating a display apparatus according to one or more embodiments of the present disclosure.

Referring to FIG. 1, the display apparatus includes a display panel 100 and a display panel driver. The display panel driver includes a driving controller 200, a gate driver 300, a gamma reference voltage generator 400, a data driver 500, and an emission driver 600.

The display panel 100 has a display region on which an image is displayed and a peripheral region adjacent to the display region.

The display panel 100 includes a plurality of gate lines GL, a plurality of data lines DL, a plurality of emission lines EL, and a plurality of pixels electrically connected to the gate lines GL, the data lines DL, and the emission lines EL. The gate lines GL may extend in a first direction D1, the data lines DL may extend in a second direction D2 crossing the first direction D1, and the emission lines EL may extend in the first direction D1.

The driving controller 200 receives input image data IMG and an input control signal CONT from an external apparatus (e.g., a processor). For example, the input image data IMG may include red image data, green image data, and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 generates gate signals driving the gate lines GL in response to the first control signal CONT1 received from the driving controller 200. The gate driver 300 may output the gate signals to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In one or more embodiments, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL.

The emission driver 600 may generate emission signals to drive the emission lines EL in response to the fourth control signal CONT4 received from the driving controller 200. The emission driver 600 may output the emission signals to the emission lines EL.

Although the gate driver 300 is disposed at a first side of the display panel 100 and the emission driver 600 is disposed at a second side of the display panel 100 opposite to the first side in FIG. 1 for convenience of explanation, the present disclosure may not be limited thereto. For example, both of the gate driver 300 and the emission driver 600 may be disposed at the first side of the display panel 100. For example, both of the gate driver 300 and the emission driver 600 may be disposed at both sides (e.g. the first side and the second side) of the display panel 100. For example, the gate driver 300 and the emission driver 600 may be integrally formed.

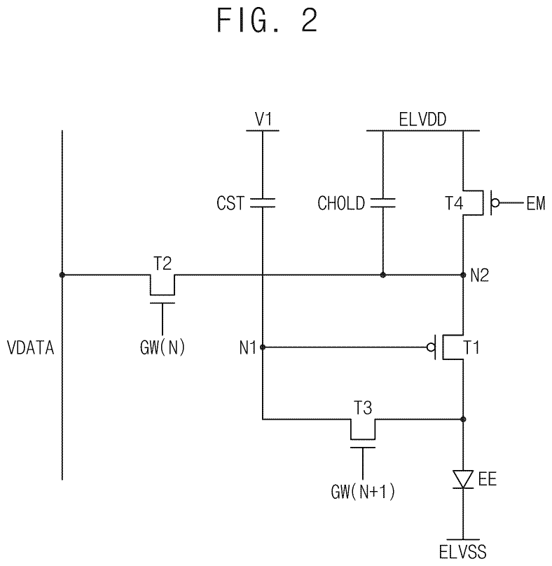

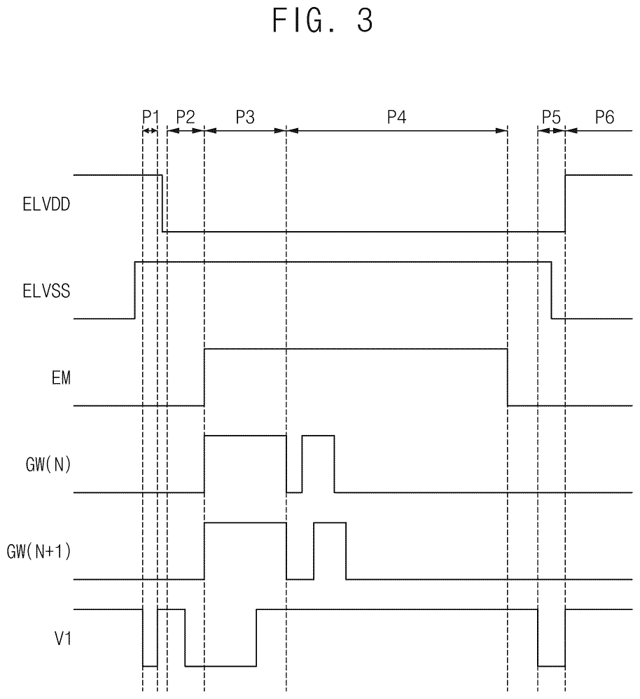

FIG. 2 is a circuit diagram illustrating a pixel of the display panel 100 of FIG. 1. FIG. 3 is a timing diagram illustrating an example of input signals applied to the pixel of FIG. 2.

Referring to FIGS. 1-3, the display panel 100 includes the plurality of the pixels. Each pixel includes a light emitting element EE. For example, the light emitting element EE may be a micro organic light emitting diode (Micro-OLED).

For example, the display apparatus according to the present embodiment may be a micro display apparatus including the micro organic light emitting diode (Micro-OLED). For example, the pixel may be formed on a glass. For example, the display apparatus may be a micro display apparatus including the pixels formed on the glass.

The pixel receives a first gate signal (e.g., GW(N)) and a second gate signal (e.g., GW(N+1)), the data voltage VDATA and the emission signal EM, and the light emitting element EE of the pixel emits light corresponding to the level of the data voltage VDATA to display the image.

The first gate signal may be an N-th gate signal GW(N). The second gate signal may be an N+1-th gate signal GW(N+1). Herein, N is a positive integer. The first gate signal GW(N) and the second gate signal GW(N+1) may be generated by the same driver.

The pixel includes the light emitting element EE, a first transistor T1, a second transistor T2, a third transistor T3, and a fourth transistor T4.

The first transistor T1 includes a control electrode connected to a first node N1, a first electrode connected to a second node N2, and a second electrode connected to an anode electrode of the light emitting element EE.

The second transistor T2 includes a control electrode receiving the first gate signal GW(N), a first electrode receiving the data voltage VDATA and a second electrode connected to the second node N2.

The third transistor T3 includes a control electrode receiving the second gate signal GW(N+1), a first electrode connected to the first node N1, and a second electrode connected to the anode electrode of the light emitting element EE.

The fourth transistor T4 includes a control electrode receiving the emission signal EM, a first electrode receiving a first power voltage ELVDD, and a second electrode connected to the second node N2.

The pixel may further include a first capacitor CST including a first electrode receiving a first voltage V1 and a second electrode connected to the first node N1.

The pixel may also include a second capacitor CHOLD including a first electrode receiving the first power voltage ELVDD and a second electrode connected to the second node N2.

A second power voltage ELVSS may be applied to a cathode electrode of the light emitting element EE.

For example, the first power voltage ELVDD may have a high level for light emission of the light emitting element EE in a light emitting period and the second power voltage ELVSS may have a low level for light emission of the light emitting element EE in the light emitting period. The high level of the first power voltage ELVDD may be greater than the low level of the second power voltage ELVSS.

The second transistor T2 may write the data voltage VDATA to the first electrode of the first transistor T1 in response to the first gate signal GW(N). The data voltage VDATA may be written to the pixel without capacitance distribution so that an influence of process deviations of the capacitors may be reduced, and accordingly, a display quality of the display panel 100 may be enhanced.

For example, the first transistor T1 may be a P-type transistor. For example, the second transistor T2 may be a P-type transistor or an N-type transistor. For example, the third transistor T3 may be a P-type transistor or an N-type transistor. When the second transistor T2 is a P-type transistor, the third transistor T3 may be a P-type transistor. In contrast, when the second transistor T2 is an N-type transistor, the third transistor T3 may be an N-type transistor. The fourth transistor T4 may be a P-type transistor or an N-type transistor.

For example, as shown in FIG. 2, the first transistor T1 and the fourth transistor T4 may be P-type transistors. For example, the second transistor T2 and the third transistor T3 may be N-type transistors.

For example, the first transistor T1 and the fourth transistor T4 may be low temperature polysilicon (LTPS) thin film transistors (TFTs). For example, the second transistor T2 and the third transistor T3 may be oxide semiconductor transistors.

As shown in FIG. 3, for example, a level of the first power voltage ELVDD may vary between a high level and a low level according to time and a level of the second power voltage ELVSS may vary between a high level and a low level according to time in a driving timing (e.g., driving period) of the pixel. In the light emitting period, the first power voltage ELVDD may have the high level and the second power voltage ELVSS may have the low level.

For example, a level of the first voltage V1 may vary between a high level and a low level according to time in the driving timing of the pixel.

The driving timing of the pixel may include a first period P1, a second period P2, a third period P3, a fourth period P4, a fifth period P5, and a sixth period P6.

In the first period P1 of the driving timing of the pixel, the first power voltage ELVDD may have the high level, the second power voltage ELVSS may have the high level, the emission signal EM may have an active level, the first gate signal GW(N) may have an inactive level, the second gate signal GW(N+1) may have an inactive level, and the first voltage V1 may have the low level.

Herein, when the signals are applied to P-type transistors, the active levels of the signals may be low levels and the inactive levels of the signals may be high levels. In contrast, when the signals are applied to N-type transistors, the active levels of the signals may be high levels and the inactive levels of the signals may be low levels.

For example, in FIG. 2, the second transistor T2 and the third transistor are N-type transistors so that an active level of the first gate signal GW(N) applied to the control electrode of the second transistor T2 may be a high level, an inactive level of the first gate signal GW(N) may be a low level, an active level of the second gate signal GW(N+1) applied to the control electrode of the third transistor T3 may be a high level and an inactive level of the second gate signal GW(N+1) may be a low level.

For example, in FIG. 2, the fourth transistor T4 is a P-type transistor so that an active level of the emission signal EM applied to the control electrode of the fourth transistor T4 may be a low level and an inactive level of the emission signal EM may be a high level.

For example, the first period P1 may be a bias period.

In the first period P1, the fourth transistor T4 may be turned on so that the high level of the first power voltage ELVDD may be applied to the first electrode of the first transistor T1.

In addition, as the level of the first voltage V1 decreases from the high level to the low level in the first period P1, a voltage level of the control electrode of the first transistor T1 may be changed.

A bias operation may be performed in the first period P1 by applying the voltages to the first electrode and the control electrode of the first transistor T1 in the first period P1.

In the second period P2 subsequent to the first period P1, the first power voltage ELVDD may have the low level, the second power voltage ELVSS may have the high level, the emission signal EM may have the active level, the first gate signal GW(N) may have the inactive level, the second gate signal GW(N+1) may have the inactive level, and the first voltage V1 may sequentially have the high level and the low level.

For example, the second period P2 may be an anode initialization period.

In the second period P2, the fourth transistor T4 may be turned on so that the low level of the first power voltage ELVDD may be applied to the first electrode of the first transistor T1.

In addition, as the level of the first voltage V1 decreases from the high level to the low level in the second period P2, the voltage level of the control electrode of the first transistor T1 may be changed and the first transistor T1 may be turned on.

As the fourth transistor T4 and the first transistor T1 are turned on in the second period P2, the low level of the first power voltage ELVDD may be applied to the anode electrode of the light emitting element EE so that the anode electrode may be initialized.

In the third period P3 subsequent to the second period P2, the first power voltage ELVDD may have the low level, the second power voltage ELVSS may have the high level, the emission signal EM may have an inactive level, the first gate signal GW(N) may have an active level, the second gate signal GW(N+1) may have an active level, and the first voltage V1 may sequentially have the low level and the high level.

For example, the third period P3 may be a first capacitor initialization period. In the third period P3, the data voltage VDATA may have a reference voltage for a first capacitor initialization.

In the third period P3, the second transistor T2 may be turned on by the first gate signal GW(N) and the third transistor T3 may be turned on by the second gate signal GW(N+1).

In the third period P3, the first voltage V1 applied to the first electrode of the first capacitor CST may have the low level. In a later portion of the third period P3, the first voltage V1 applied to the first capacitor CST may increase from the low level to the high level.

In the fourth period P4 subsequent to the third period P3, the first power voltage ELVDD may have the low level, the second power voltage ELVSS may have the high level, the emission signal EM may have the inactive level, the first gate signal GW(N) may have at least one active pulse, the second gate signal GW(N+1) may have at least one active pulse, and the first voltage V1 may have the high level.

For example, the fourth period P4 may be a data writing and compensating period. In the fourth period P4, the data voltage VDATA may have a grayscale data voltage corresponding to a pixel.

The first gate signal GW(N) and the second gate signal GW(N+1) may have the same waveform in the first period P1, the second period P2, and the third period P3 of the driving timing of the pixel. The first gate signal GW(N) and the second gate signal GW(N+1) may have the same waveform in the fifth period P5 and the sixth period P6 of the driving timing of the pixel.

The first gate signal GW(N) and the second gate signal GW(N+1) may have progressive waveforms in the fourth period P4 subsequent to the third period P3 of the driving timing of the pixel.

In the fourth period P4, an active pulse of the first gate signal GW(N) and an active pulse of the second gate signal GW(N+1) may be partially overlapped.

In the fourth period P4, the second transistor T2 may be turned on corresponding to the active pulse of the first gate signal GW(N) and the third transistor T3 may be turned on corresponding to the active pulse of the second gate signal GW(N+1).

In the fourth period P4, the grayscale data voltage, in which a threshold voltage of the first transistor T1 is compensated by the second transistor T2 and the third transistor T3 which are turned on, may be written to the control electrode of the first transistor T1.

In the fifth period P5 subsequent to the fourth period P4, the first power voltage ELVDD may have the low level, the second power voltage ELVSS may sequentially have the high level and the low level, the emission signal EM may have the active level, the first gate signal GW(N) may have the inactive level, the second gate signal GW(N+1) may have the inactive level, and the first voltage V1 may have the low level.

For example, the fifth period P5 may be a second anode initialization period.

In the fifth period P5, the fourth transistor T4 may be turned on so that the low level of the first power voltage ELVDD may be applied to the first electrode of the first transistor T1.

In addition, as the level of the first voltage V1 decreases from the high level to the low level in the fifth period P5, the voltage level of the control electrode of the first transistor T1 may be changed and the first transistor T1 may be turned on.

As the fourth transistor T4 and the first transistor T1 are turned on in the fifth period P5, the low level of the first power voltage ELVDD may be applied to the anode electrode of the light emitting element EE so that the anode electrode may be initialized.

In the sixth period P6 subsequent to the fifth period P5, the first power voltage ELVDD may have the high level, the second power voltage ELVSS may have the low level, the emission signal EM may have the active level, the first gate signal GW(N) may have the inactive level, the second gate signal GW(N+1) may have the inactive level, and the first voltage V1 may have the high level.

For example, the sixth period P6 may be the light emitting period.

In the sixth period P6, the first transistor T1 and the fourth transistor T4 may be turned on and the second transistor T2 and the third transistor T3 may be turned off.

In the sixth period P6, the first power voltage ELVDD may be applied to the first transistor T1 so that a driving current may be generated. In the sixth period P6, the driving current may be applied to the light emitting element EE. For example, the light emitting element EE may emit a light corresponding to the driving current. The driving current may be determined according to a gate-source voltage of the first transistor T1.

According to the present embodiment, the data voltage VDATA may be written to the pixel without capacitance distribution so that an influence of process deviations of the capacitors may be reduced, and accordingly, a display quality of the display panel 100 may be enhanced.

In addition, the first gate signal GW(N) applied to the second transistor T2 and the second gate signal GW(N+1) applied to the third transistor T3 may be generated by the same driver so that an area occupied by the gate driver 300 may be reduced and a manufacturing cost of the display apparatus may be reduced.

In addition, the pixel may include four transistors T1, T2, T3 and T4 and two capacitors CST and CHOLD. The pixel includes a relatively small number of transistors and a relatively small number of capacitors so that the pixel may be applied to a high-resolution display apparatus.

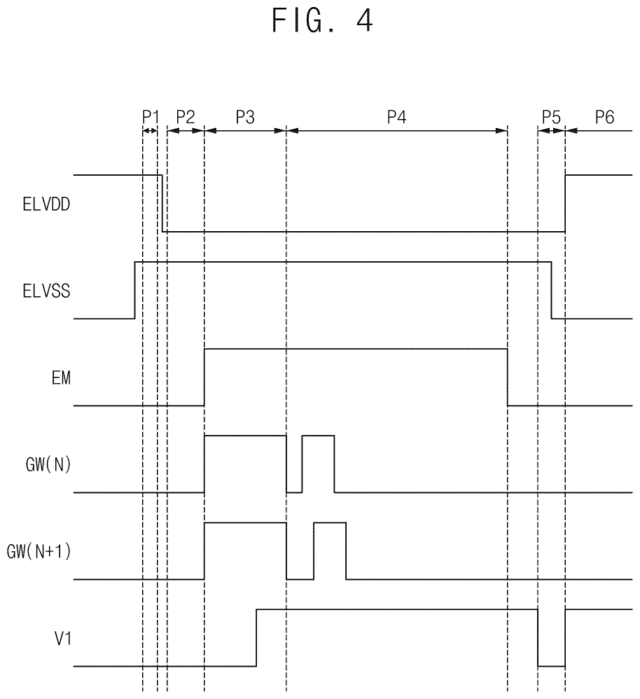

FIG. 4 is a timing diagram illustrating an example of input signals applied to the pixel of FIG. 2.

The timing diagram of FIG. 4 is substantially the same as the timing diagram of FIG. 3 except for a waveform of the first voltage V1 in the second period P2.

Referring to FIGS. 1, 2 and 4, the driving timing of the pixel may include a first period P1, a second period P2, a third period P3, a fourth period P4, a fifth period P5, and a sixth period P6.

In the first period P1 of the driving timing of the pixel, the first power voltage ELVDD may have the high level, the second power voltage ELVSS may have the high level, the emission signal EM may have an active level, the first gate signal GW(N) may have an inactive level, the second gate signal GW(N+1) may have an inactive level, and the first voltage V1 may have the low level.

For example, the first period P1 may be a bias period.

In the second period P2 subsequent to the first period P1, the first power voltage ELVDD may have the low level, the second power voltage ELVSS may have the high level, the emission signal EM may have the active level, the first gate signal GW(N) may have the inactive level, the second gate signal GW(N+1) may have the inactive level, and the first voltage V1 may maintain the low level.

For example, the second period P2 may be an anode initialization period.

In the third period P3 subsequent to the second period P2, the first power voltage ELVDD may have the low level, the second power voltage ELVSS may have the high level, the emission signal EM may have an inactive level, the first gate signal GW(N) may have an active level, the second gate signal GW(N+1) may have an active level, and the first voltage V1 may sequentially have the low level and the high level.

For example, the third period P3 may be a first capacitor initialization period. In the third period P3, the data voltage VDATA may have a reference voltage for a first capacitor initialization.

In the fourth period P4 subsequent to the third period P3, the first power voltage ELVDD may have the low level, the second power voltage ELVSS may have the high level, the emission signal EM may have the inactive level, the first gate signal GW(N) may have at least one active pulse, the second gate signal GW(N+1) may have at least one active pulse, and the first voltage V1 may have the high level.

For example, the fourth period P4 may be a data writing and compensating period. In the fourth period P4, the data voltage VDATA may have a grayscale data voltage corresponding to a pixel.

In the fifth period P5 subsequent to the fourth period P4, the first power voltage ELVDD may have the low level, the second power voltage ELVSS may sequentially have the high level and the low level, the emission signal EM may have the active level, the first gate signal GW(N) may have the inactive level, the second gate signal GW(N+1) may have the inactive level, and the first voltage V1 may have the low level.

For example, the fifth period P5 may be a second anode initialization period.

In the sixth period P6 subsequent to the fifth period P5, the first power voltage ELVDD may have the high level, the second power voltage ELVSS may have the low level, the emission signal EM may have the active level, the first gate signal GW(N) may have the inactive level, the second gate signal GW(N+1) may have the inactive level, and the first voltage V1 may have the high level.

For example, the sixth period P6 may be the light emitting period.

According to the present embodiment, the data voltage VDATA may be written to the pixel without capacitance distribution so that an influence of process deviations of the capacitors may be reduced, and accordingly, a display quality of the display panel 100 may be enhanced.

In addition, the first gate signal GW(N) applied to the second transistor T2 and the second gate signal GW(N+1) applied to the third transistor T3 may be generated by the same driver so that an area occupied by the gate driver 300 may be reduced and a manufacturing cost of the display apparatus may be reduced.

In addition, the pixel may include four transistors T1, T2, T3 and T4 and two capacitors CST and CHOLD. The pixel includes a relatively small number of transistors and a relatively small number of capacitors so that the pixel may be applied to a high-resolution display apparatus.

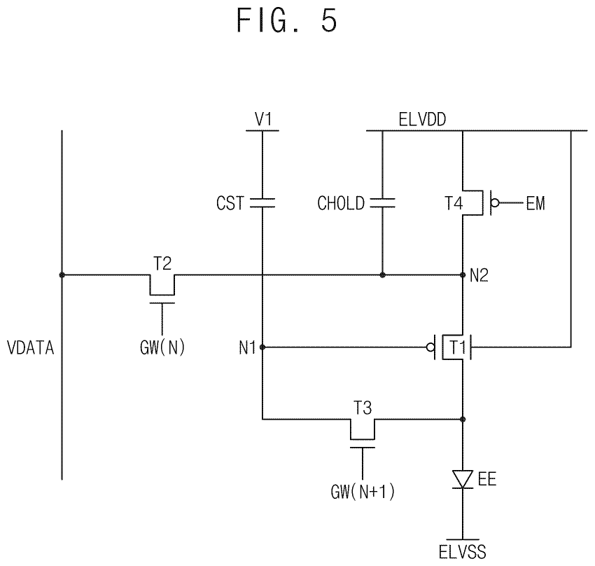

FIG. 5 is a circuit diagram illustrating a pixel of a display panel 100 of a display apparatus according to one or more embodiments of the present disclosure.

The display apparatus according to the present embodiment is substantially the same as the display apparatus of the previous embodiment discussed in reference to FIGS. 1-4, except for the structure of the first transistor of the pixel. Thus, the same reference numerals will be used to refer to the same or like parts as those described in the previous embodiment of FIGS. 1-4 and any repetitive explanation concerning the above elements will be omitted.

Referring to FIGS. 1 and 3-5, the display panel 100 includes the plurality of the pixels. Each pixel includes a light emitting element EE. For example, the light emitting element EE may be a micro organic light emitting diode (Micro-OLED).

For example, the display apparatus according to the present embodiment may be a micro display apparatus including the micro organic light emitting diode (Micro-OLED). For example, the pixel may be formed on a glass. For example, the display apparatus may be a micro display apparatus including the pixels formed on the glass.

The pixel receives a first gate signal (e.g., GW(N)) and a second gate signal (e.g., GW(N+1)), the data voltage VDATA, and the emission signal EM, and the light emitting element EE of the pixel emits light corresponding to the level of the data voltage VDATA to display the image.

The pixel includes the light emitting element EE, a first transistor T1, a second transistor T2, a third transistor T3, and a fourth transistor T4.

The first transistor T1 includes a control electrode connected to a first node N1, a first electrode connected to a second node N2, and a second electrode connected to an anode electrode of the light emitting element EE.

The second transistor T2 includes a control electrode receiving the first gate signal GW(N), a first electrode receiving the data voltage VDATA, and a second electrode connected to the second node N2.

The third transistor T3 includes a control electrode receiving the second gate signal GW(N+1), a first electrode connected to the first node N1, and a second electrode connected to the anode electrode of the light emitting element EE.

The fourth transistor T4 includes a control electrode receiving the emission signal EM, a first electrode receiving a first power voltage ELVDD, and a second electrode connected to the second node N2.

The pixel may further include a first capacitor CST including a first electrode receiving a first voltage V1 and a second electrode connected to the first node N1.

The pixel may further include a second capacitor CHOLD including a first electrode receiving the first power voltage ELVDD and a second electrode connected to the second node N2.

A second power voltage ELVSS may be applied to a cathode electrode of the light emitting element EE.

In the present embodiment, the first transistor T1 may further include a second control electrode receiving the first power voltage ELVDD. The first transistor T1 further includes the second control electrode receiving the first power voltage ELVDD so that a threshold voltage of the first transistor T1 may be controlled.

According to the present embodiment, the data voltage VDATA may be written to the pixel without capacitance distribution so that an influence of process deviations of the capacitors may be reduced, and accordingly, a display quality of the display panel 100 may be enhanced.

In addition, the first gate signal GW(N) applied to the second transistor T2 and the second gate signal GW(N+1) applied to the third transistor T3 may be generated by the same driver so that an area occupied by the gate driver 300 may be reduced and a manufacturing cost of the display apparatus may be reduced.

In addition, the pixel may include four transistors T1, T2, T3, and T4 and two capacitors CST and CHOLD. The pixel includes a relatively small number of transistors and a relatively small number of capacitors so that the pixel may be applied to a high-resolution display apparatus.

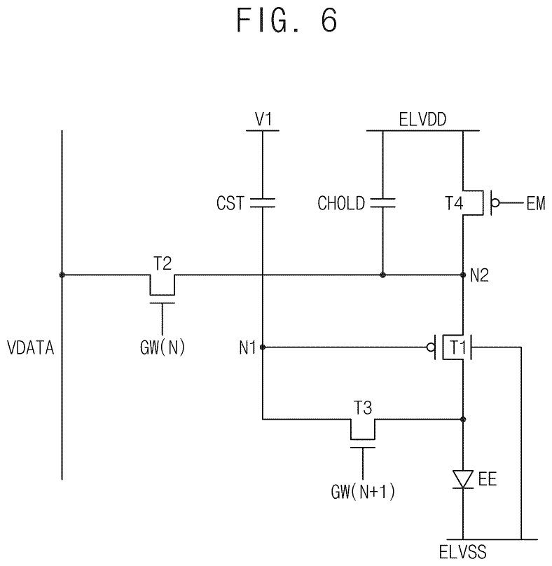

FIG. 6 is a circuit diagram illustrating a pixel of a display panel 100 of a display apparatus according to one or more embodiments of the present disclosure.

The display apparatus according to the present embodiment is substantially the same as the display apparatus of the previous embodiment discussed in reference to FIGS. 1-4 except for the structure of the first transistor of the pixel. Thus, the same reference numerals will be used to refer to the same or like parts as those described in the previous embodiment of FIGS. 1-4 and any repetitive explanation concerning the above elements will be omitted.

Referring to FIGS. 1, 3, 4, and 6, the display panel 100 includes the plurality of the pixels. Each pixel includes a light emitting element EE. For example, the light emitting element EE may be a micro organic light emitting diode (Micro-OLED).

For example, the display apparatus according to the present embodiment may be a micro display apparatus including the micro organic light emitting diode (Micro-OLED). For example, the pixel may be formed on a glass. For example, the display apparatus may be a micro display apparatus including the pixels formed on the glass.

The pixel receives a first gate signal (e.g., GW(N)) and a second gate signal (e.g., GW(N+1)) the data voltage VDATA and the emission signal EM, and the light emitting element EE of the pixel emits light corresponding to the level of the data voltage VDATA to display the image.

The pixel includes the light emitting element EE, a first transistor T1, a second transistor T2, a third transistor T3, and a fourth transistor T4.

The first transistor T1 includes a control electrode connected to a first node N1, a first electrode connected to a second node N2, and a second electrode connected to an anode electrode of the light emitting element EE.

The second transistor T2 includes a control electrode receiving the first gate signal GW(N), a first electrode receiving the data voltage VDATA, and a second electrode connected to the second node N2.

The third transistor T3 includes a control electrode receiving the second gate signal GW(N+1), a first electrode connected to the first node N1, and a second electrode connected to the anode electrode of the light emitting element EE.

The fourth transistor T4 includes a control electrode receiving the emission signal EM, a first electrode receiving a first power voltage ELVDD, and a second electrode connected to the second node N2.

The pixel may further include a first capacitor CST including a first electrode receiving a first voltage V1 and a second electrode connected to the first node N1.

The pixel may further include a second capacitor CHOLD including a first electrode receiving the first power voltage ELVDD and a second electrode connected to the second node N2.

A second power voltage ELVSS may be applied to a cathode electrode of the light emitting element EE.

In the present embodiment, the first transistor T1 may further include a second control electrode receiving the second power voltage ELVSS. The first transistor T1 further includes the second control electrode receiving the second power voltage ELVSS so that a threshold voltage of the first transistor T1 may be controlled.

According to the present embodiment, the data voltage VDATA may be written to the pixel without capacitance distribution so that an influence of process deviations of the capacitors may be reduced, and accordingly, a display quality of the display panel 100 may be enhanced.

In addition, the first gate signal GW(N) applied to the second transistor T2 and the second gate signal GW(N+1) applied to the third transistor T3 may be generated by the same driver so that an area occupied by the gate driver 300 may be reduced and a manufacturing cost of the display apparatus may be reduced.

In addition, the pixel may include four transistors T1, T2, T3 and T4 and two capacitors CST and CHOLD. The pixel includes a relatively small number of transistors and a relatively small number of capacitors so that the pixel may be applied to a high-resolution display apparatus.

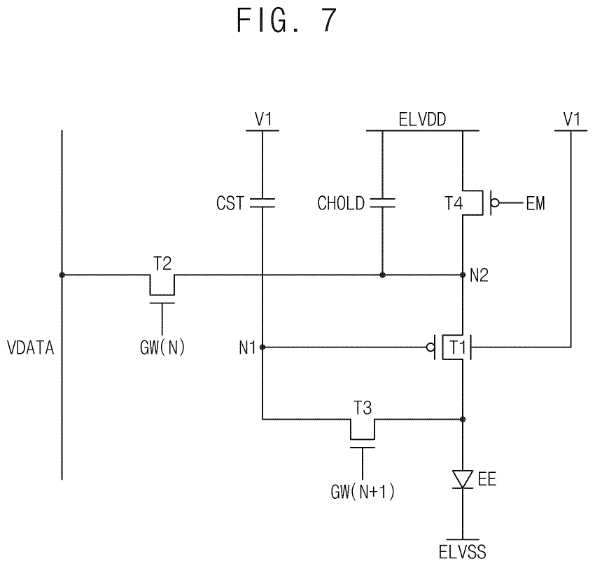

FIG. 7 is a circuit diagram illustrating a pixel of a display panel 100 of a display apparatus according to one or more embodiments of the present disclosure.

The display apparatus according to the present embodiment is substantially the same as the display apparatus of the previous embodiment discussed in reference to FIGS. 1-4 except for the structure of the first transistor of the pixel. Thus, the same reference numerals will be used to refer to the same or like parts as those described in the previous embodiment of FIGS. 1-4 and any repetitive explanation concerning the above elements will be omitted.

Referring to FIGS. 1, 3, 4, and 7, the display panel 100 includes the plurality of the pixels. Each pixel includes a light emitting element EE. For example, the light emitting element EE may be a micro organic light emitting diode (Micro-OLED).

For example, the display apparatus according to the present embodiment may be a micro display apparatus including the micro organic light emitting diode (Micro-OLED). For example, the pixel may be formed on a glass. For example, the display apparatus may be a micro display apparatus including the pixels formed on the glass.

The pixel receives a first gate signal (e.g., GW(N)) and a second gate signal (e.g., GW(N+1)), the data voltage VDATA, and the emission signal EM, and the light emitting element EE of the pixel emits light corresponding to the level of the data voltage VDATA to display the image.

The pixel includes the light emitting element EE, a first transistor T1, a second transistor T2, a third transistor T3, and a fourth transistor T4.

The first transistor T1 includes a control electrode connected to a first node N1, a first electrode connected to a second node N2, and a second electrode connected to an anode electrode of the light emitting element EE.

The second transistor T2 includes a control electrode receiving the first gate signal GW(N), a first electrode receiving the data voltage VDATA, and a second electrode connected to the second node N2.

The third transistor T3 includes a control electrode receiving the second gate signal GW(N+1), a first electrode connected to the first node N1, and a second electrode connected to the anode electrode of the light emitting element EE.

The fourth transistor T4 includes a control electrode receiving the emission signal EM, a first electrode receiving a first power voltage ELVDD, and a second electrode connected to the second node N2.

The pixel may further include a first capacitor CST including a first electrode receiving a first voltage V1 and a second electrode connected to the first node N1.

The pixel may further include a second capacitor CHOLD including a first electrode receiving the first power voltage ELVDD and a second electrode connected to the second node N2.

A second power voltage ELVSS may be applied to a cathode electrode of the light emitting element EE.

In the present embodiment, the first transistor T1 may further include a second control electrode receiving the first voltage V1. The first transistor T1 further includes the second control electrode receiving the first voltage V1 so that a threshold voltage of the first transistor T1 may be controlled.

According to the present embodiment, the data voltage VDATA may be written to the pixel without capacitance distribution so that an influence of process deviations of the capacitors may be reduced, and accordingly, a display quality of the display panel 100 may be enhanced.

In addition, the first gate signal GW(N) applied to the second transistor T2 and the second gate signal GW(N+1) applied to the third transistor T3 may be generated by the same driver so that an area occupied by the gate driver 300 may be reduced and a manufacturing cost of the display apparatus may be reduced.

In addition, the pixel may include four transistors T1, T2, T3, and T4 and two capacitors CST and CHOLD. The pixel includes a relatively small number of transistors and a relatively small number of capacitors so that the pixel may be applied to a high-resolution display apparatus.

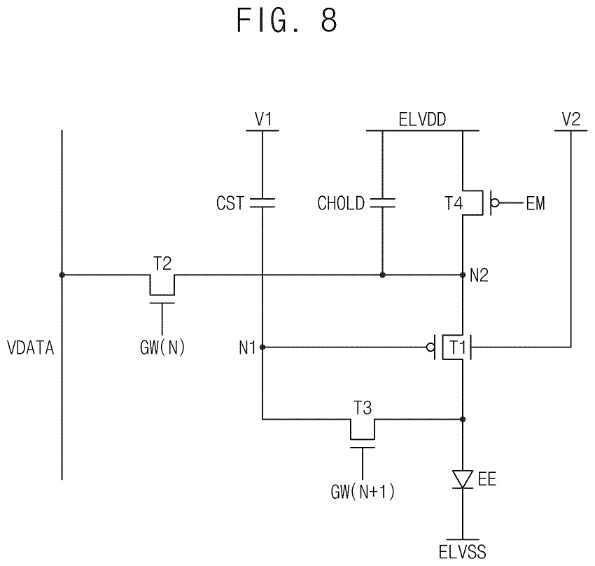

FIG. 8 is a circuit diagram illustrating a pixel of a display panel 100 of a display apparatus according to one or more embodiments of the present disclosure.

The display apparatus according to the present embodiment is substantially the same as the display apparatus of the previous embodiment discussed in reference to FIGS. 1-4 except for the structure of the first transistor of the pixel. Thus, the same reference numerals will be used to refer to the same or like parts as those described in the previous embodiment of FIGS. 1-4 and any repetitive explanation concerning the above elements will be omitted.

Referring to FIGS. 1, 3, 4, and 8, the display panel 100 includes the plurality of the pixels. Each pixel includes a light emitting element EE. For example, the light emitting element EE may be a micro organic light emitting diode (Micro-OLED).

For example, the display apparatus according to the present embodiment may be a micro display apparatus including the micro organic light emitting diode (Micro-OLED). For example, the pixel may be formed on a glass. For example, the display apparatus may be a micro display apparatus including the pixels formed on the glass.

The pixel receives a first gate signal (e.g., GW(N)) and a second gate signal (e.g., GW(N+1)), the data voltage VDATA, and the emission signal EM, and the light emitting element EE of the pixel emits light corresponding to the level of the data voltage VDATA to display the image.

The pixel includes the light emitting element EE, a first transistor T1, a second transistor T2, a third transistor T3, and a fourth transistor T4.

The first transistor T1 includes a control electrode connected to a first node N1, a first electrode connected to a second node N2, and a second electrode connected to an anode electrode of the light emitting element EE.

The second transistor T2 includes a control electrode receiving the first gate signal GW(N), a first electrode receiving the data voltage VDATA, and a second electrode connected to the second node N2.

The third transistor T3 includes a control electrode receiving the second gate signal GW(N+1), a first electrode connected to the first node N1, and a second electrode connected to the anode electrode of the light emitting element EE.

The fourth transistor T4 includes a control electrode receiving the emission signal EM, a first electrode receiving a first power voltage ELVDD, and a second electrode connected to the second node N2.

The pixel may further include a first capacitor CST including a first electrode receiving a first voltage V1 and a second electrode connected to the first node N1.

The pixel may further include a second capacitor CHOLD including a first electrode receiving the first power voltage ELVDD and a second electrode connected to the second node N2.

A second power voltage ELVSS may be applied to a cathode electrode of the light emitting element EE.

In the present embodiment, the first transistor T1 may further include a second control electrode receiving a second voltage V2 which is different from the first voltage V1, the first power voltage ELVDD and the second power voltage ELVSS. For example, the second voltage V2 may be a direct-current (DC) voltage. The first transistor T1 further includes the second control electrode receiving the second voltage V2 so that a threshold voltage of the first transistor T1 may be controlled.

According to the present embodiment, the data voltage VDATA may be written to the pixel without capacitance distribution so that an influence of process deviations of the capacitors may be reduced, and accordingly, a display quality of the display panel 100 may be enhanced.

In addition, the first gate signal GW(N) applied to the second transistor T2 and the second gate signal GW(N+1) applied to the third transistor T3 may be generated by the same driver so that an area occupied by the gate driver 300 may be reduced and a manufacturing cost of the display apparatus may be reduced.

In addition, the pixel may include four transistors T1, T2, T3, and T4 and two capacitors CST and CHOLD. The pixel includes a relatively small number of transistors and a relatively small number of capacitors so that the pixel may be applied to a high-resolution display apparatus.

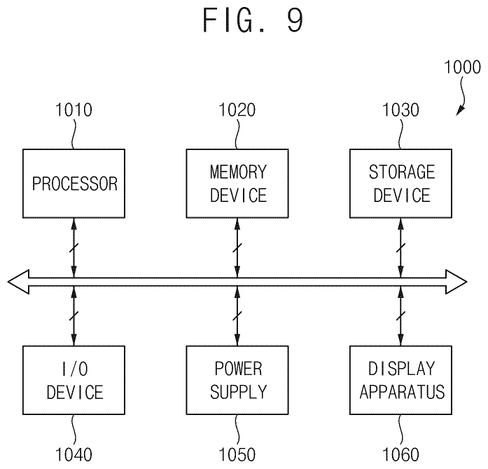

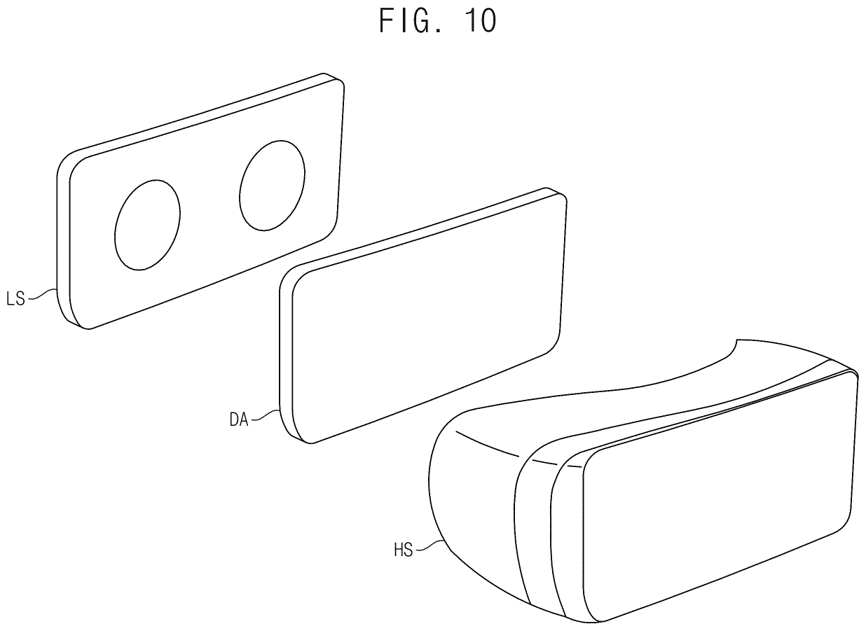

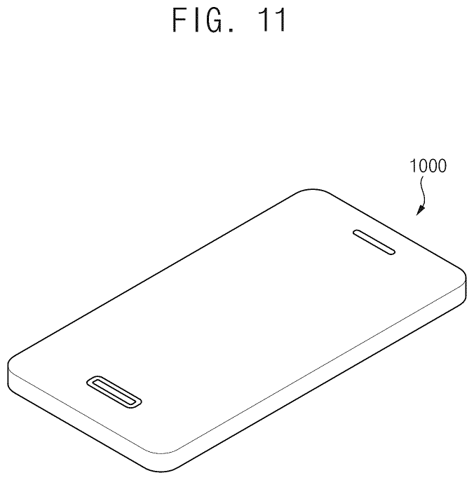

FIG. 9 is a block diagram illustrating an electronic apparatus 1000 according to one or more embodiments of the present disclosure. FIG. 10 is a diagram illustrating an example in which the electronic apparatus 1000 of FIG. 9 is implemented as a virtual reality display system. FIG. 11 is a diagram illustrating an example in which the electronic apparatus 1000 of FIG. 9 is implemented as a smart phone.

Referring to FIGS. 1-11, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In one or more embodiments, as illustrated in FIG. 11, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head mounted display (HMD) device, and/or the like.

The processor 1010 may perform various computing functions or various tasks. The processor 1010 may be a micro-processor, a central processing unit (CPU), an application processor (AP), and/or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and/or the like.

The storage device 1030 may include a solid state drive (SSD) device, a hard disk drive (HDD) device, a CD-ROM device, and/or the like. The I/O device 1040 may include an input device such as a keyboard, a keypad, a mouse device, a touch-pad, a touch-screen, and/or the like and an output device such as a printer, a speaker, and the like. In one or more embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 10, the virtual reality (VR) display system may include a lens LS, a display apparatus DA, and a housing HS. The display apparatus DA may be disposed adjacent to the lens LS. The housing HS may receive the lens LS and the display apparatus DA. Although the lens LS and the display apparatus DA are received on a first side of the housing HS in FIG. 10, the present disclosure may not be limited thereto. For example, the lens LS may be received on a first side of the housing HS and the display apparatus DA may be received on a second side of the housing HS opposite to the first side of the housing HS. When the lens LS and the display apparatus DA are received on opposite sides with respect to the housing HS, the housing HS may have a transmitting portion to transmit a light.

For example, the VR display system may be a head mounted display system worn on a user's head. In one or more embodiments, the VR display system may further include a head band to fix the VR display system to the user's head.

Alternatively, the VR display system may have a form of smart glasses designed as a shape of glasses.

In addition, the electronic apparatus may be implemented as an augmented reality (AR) display system for supporting an augmented reality. The AR display system may have a smartphone shape, a smart glasses shape, a head mounted display shape, etc., but may not be limited to those shapes.

In addition, the electronic apparatus may be implemented as a mixed reality (MR) display system for supporting a mixed reality. The MR display system may have a smartphone shape, a smart glasses shape, a head mounted display shape, etc., but may not be limited to those shapes.

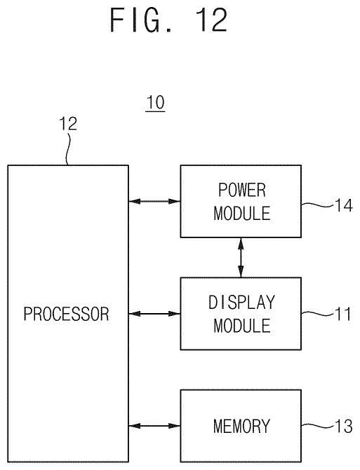

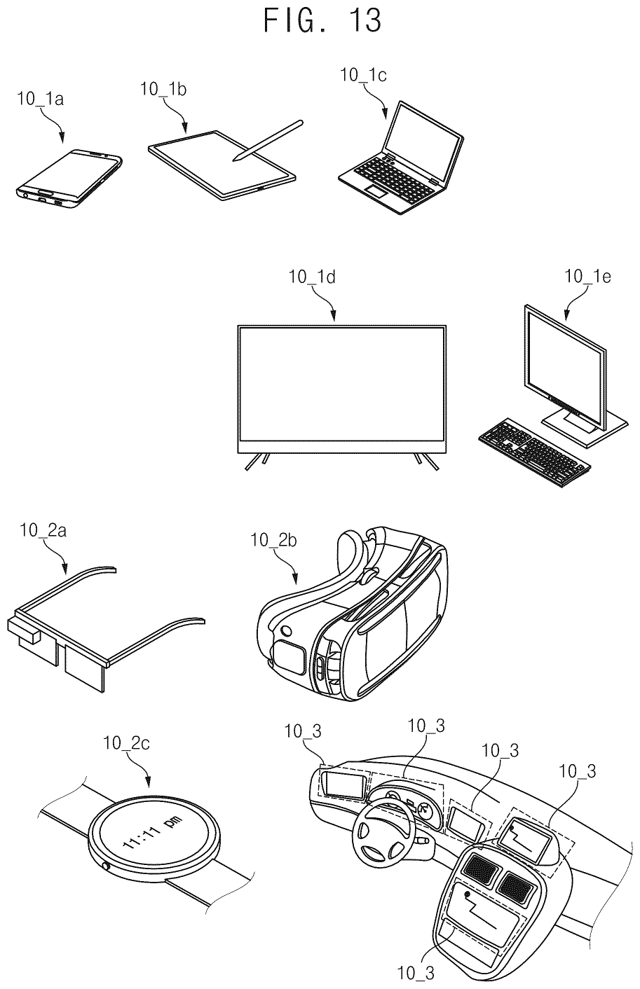

FIG. 12 is a block diagram illustrating an electronic apparatus 10 according to one or more embodiments of the present disclosure. FIG. 13 is a diagram illustrating examples of the electronic apparatus 10 of FIG. 12.

Referring to FIG. 12, the electronic apparatus 10 may include a display module 11, a processor 12, a memory 13 and a power module 14.

The display apparatus according to embodiments of the present inventive concept may be applied to various electronic apparatuses.

In an embodiment, the electronic apparatus 10 may include the display apparatus of FIG. 1. For example, an operation of the display apparatus included in the electronic apparatus 10 may be substantially the same as the operation of the display apparatus discussed in reference to FIGS. 1-8. The electronic apparatus 10 may further include an additional module or an additional apparatus having a function different from a function of the display apparatus.

The processor 12 may include at least one of a central processing unit (CPU), an application processor (AP), a graphic processing unit (GPU), a communication processor (CP), an image signal processor (ISP), and/or a controller.

In one or more embodiments, the processor 12 may provide the input control signal CONT of FIG. 1 and the input image data IMG of FIG. 1 to the driving controller 200 included in the display apparatus of FIG. 1.

In one or more embodiments, the processor 12 may be divided into two or more modules functionally or structurally. For example, the processor 12 may include a main processor having a type of a first driving chip including the central processing unit (CPU) and a sub processor having a type of a second driving chip including the controller receiving an image signal from the main processor and processing the image signal to meet an interface specification of the display module 11. For example, the sub processor may include the driving controller 200 included in the display apparatus of FIG. 1. Thus, the main processor may provide the input control signal of FIG. 1 and the input image data IMG of FIG. 1 to the sub processor. The sub processor may process the image signal based on the input control signal CONT and the input image data IMG.

The memory 13 may include at least one of a nonvolatile memory and a volatile memory. The memory 13 may store data information needed for an operation of the processor 12 or an operation of the display module 11. When the processor 12 executes an application stored in the memory 13, the input control signal CONT and/or the input image data IMG are transmitted to the display module 11 and the display module 11 may process the input control signal CONT and/or the input image data IMG provided from the display module 11 and may output image information as a display image.

The power module 14 may include a power supply module such as a power adapter or a battery device and a power conversion module converting the power supplied by the power supply module to generate a power required for an operation of the electronic apparatus 10.

At least one of the elements of the electronic apparatus 10 may be included in the display apparatus according to the embodiments of the present disclosure. A part of an individual module which are functionally included within a single module may be included in the display apparatus and another part of the individual module may be separated from the display apparatus. For example, the display apparatus may include the display module 11 and the processor 12, the memory 13 and the power module 14 may be provided in a form of another apparatus in the electronic apparatus 10.

Referring to FIG. 13, the various electronic apparatuses to which the display apparatus according to one or more embodiments of the present disclosure is applied may include not only an image display electronic apparatus such as a smart phone 10_1a, a table PC 10_1b, a laptop 10_1c, a television 10_1d, a monitor for a desktop 10_1e and so on, but also a wearable electronic apparatus including a display module such as smart glasses 10_2a, a head mounted display 10_2b, and a smart watch 10_2c, and an automotive electronic apparatus 10_3 including a display module such as a center information display (CID) disposed on an instrument panel, a center fascia, and a dashboard of an automobile, and a room mirror display. The electronic apparatus 10 may not be limited to the image display electronic apparatus, the wearable electronic apparatus and the automotive electronic apparatus 10_3.

According to the pixel, the display apparatus and the electronic apparatus of the present disclosure as discussed above, the data voltage may be written to the pixel without capacitance distribution so that an influence of process deviations of the capacitors may be reduced, and accordingly, a display quality of the display panel may be enhanced. In addition, the pixel may be applied to a high-resolution display apparatus.

The foregoing is illustrative of the present disclosure and is not to be construed as limiting thereof. Although example embodiments of the present disclosure have been described, those skilled in the art will readily appreciate that many modifications are possible in the embodiments without materially departing from the novel teachings and scope of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims and their equivalents. The present disclosure is defined by the following claims, with equivalents of the claims to be included therein.

what is claimed is:

1. A pixel comprising:
a light emitting element;
a first transistor comprising a control electrode connected to a first node, a first electrode connected to a second node, and a second electrode connected to an anode electrode of the light emitting element;
a second transistor comprising a control electrode configured to receive a first gate signal, a first electrode configured to receive a data voltage, and a second electrode connected to the second node;
a third transistor comprising a control electrode configured to receive a second gate signal, a first electrode connected to the first node, and a second electrode connected to the anode electrode of the light emitting element; and
a fourth transistor comprising a control electrode configured to receive an emission signal, a first electrode configured to receive a first power voltage, and a second electrode connected to the second node.

2. The pixel of claim 1, further comprising a first capacitor comprising a first electrode configured to receive a first voltage and a second electrode connected to the first node.

3. The pixel of claim 2, further comprising a second capacitor comprising a first electrode configured to receive the first power voltage and a second electrode connected to the second node.

4. The pixel of claim 3, wherein the first power voltage has a high level in a first period of a driving timing of the pixel,
wherein a second power voltage applied to a cathode electrode of the light emitting element has a high level in the first period,
wherein the emission signal has an active level in the first period,
wherein the first gate signal has an inactive level in the first period,
wherein the second gate signal has an inactive level in the first period, and
wherein the first voltage has a low level in the first period.

5. The pixel of claim 4, wherein the first power voltage has a low level in a second period subsequent to the first period, wherein the second power voltage has the high level in the second
period,
wherein the emission signal has the active level in the second period,
wherein the first gate signal has the inactive level in the second period,
wherein the second gate signal has the inactive level in the second period, and
wherein the first voltage sequentially has a high level and the low level in the second period.

6. The pixel of claim 5, wherein the first power voltage has the low level in a third period subsequent to the second period,
wherein the second power voltage has the high level in the third period,
wherein the emission signal has an inactive level in the third period,
wherein the first gate signal has an active level in the third period,
wherein the second gate signal has an active level in the third period, and
wherein the first voltage sequentially has the low level and the high level in the third period.

7. The pixel of claim 6, wherein the first power voltage has the low level in a fourth period subsequent to the third period,
wherein the second power voltage has the high level in the fourth period,
wherein the emission signal has the inactive level in the fourth period,
wherein the first gate signal has at least one active pulse in the fourth period,
wherein the second gate signal has at least one active pulse in the fourth period, and
wherein the first voltage has the high level in the fourth period.

8. The pixel of claim 7, wherein the first power voltage has the low level in a fifth period subsequent to the fourth period,
wherein the second power voltage sequentially has the high level and the low level in the fifth period,
wherein the emission signal has the active level in the fifth period,
wherein the first gate signal has the inactive level in the fifth period,
wherein the second gate signal has the inactive level in the fifth period, and
wherein the first voltage has the low level in the fifth period.

9. The pixel of claim 8, wherein the first power voltage has the high level in a sixth period subsequent to the fifth period,
wherein the second power voltage has the low level in the sixth period,
wherein the emission signal has the active level in the sixth period,
wherein the first gate signal has the inactive level in the sixth period,
wherein the second gate signal has the inactive level in the sixth period, and
wherein the first voltage has the high level in the sixth period.

10. The pixel of claim 4, wherein the first power voltage has a low level in a second period subsequent to the first period,
wherein the second power voltage has the high level in the second period,
wherein the emission signal has the active level in the second period,
wherein the first gate signal has the inactive level in the second period,
wherein the second gate signal has the inactive level in the second period,
wherein the first voltage has the low level in the second period,
wherein the first power voltage has the low level in a third period subsequent to the second period,
wherein the second power voltage has the high level in the third period,
wherein the emission signal has an inactive level in the third period,
wherein the first gate signal has an active level in the third period,
wherein the second gate signal has an active level in the third period, and
wherein the first voltage sequentially has the low level and the high level in the third period.

11. The pixel of claim 2, wherein the first transistor further comprises a second control electrode configured to receive the first voltage.

12. The pixel of claim 2, wherein the first transistor further comprises a second control electrode configured to receive a second voltage that is different from the first voltage, the first power voltage, and a second power voltage applied to a cathode electrode of the light emitting element.

13. The pixel of claim 1, wherein the first transistor further comprises a second control electrode configured to receive the first power voltage.

14. The pixel of claim 1, wherein the first transistor further comprises a second control electrode configured to receive a second power voltage applied to a cathode electrode of the light emitting element.

15. The pixel of claim 1, wherein the first gate signal is an N-th gate signal,
wherein the second gate signal is an N+1-th gate signal,
wherein N is a positive integer, and
wherein the first gate signal and the second gate signal are generated by a same driver.

16. The pixel of claim 15, wherein the first gate signal and the second gate signal have substantially a same waveform in a first period, a second period and a third period of a driving timing of the pixel, and
wherein the first gate signal and the second gate signal have progressive waveforms in a fourth period of the driving timing of the pixel subsequent to the third period of the driving timing of the pixel.

17. The pixel of claim 16, wherein an active pulse of the first gate signal and an active pulse of the second gate signal are partially overlapped.

18. The pixel of claim 1, wherein the first transistor and the fourth transistor are P-type transistors, and
wherein the second transistor and the third transistor are N-type transistors.

19. A display apparatus comprising:
a display panel comprising a pixel;
a gate driver configured to output a first gate signal and a second gate signal to the pixel;
a data driver configured to output a data voltage to the pixel; and
an emission driver configured to output an emission signal to the pixel,
wherein the pixel comprises:
a light emitting element;
a first transistor comprising a control electrode connected to a first node, a first electrode connected to a second node, and a second electrode connected to an anode electrode of the light emitting element;
a second transistor comprising a control electrode configured to receive the first gate signal, a first electrode configured to receive the data voltage, and a second electrode connected to the second node;
a third transistor comprising a control electrode configured to receive the second gate signal, a first electrode connected to the first node, and a second electrode connected to the anode electrode of the light emitting element; and
a fourth transistor comprising a control electrode configured to receive the emission signal, a first electrode configured to receive a first power voltage, and a second electrode connected to the second node.

20. An electronic apparatus comprising:
a display panel comprising a pixel;
a gate driver configured to output a first gate signal and a second gate signal to the pixel;
a data driver configured to output a data voltage to the pixel;
an emission driver configured to output an emission signal to the pixel;
a driving controller configured to control the gate driver, the data driver, and the emission driver; and
a processor configured to output input image data and an input control signal to the driving controller,
wherein the pixel comprises:
a light emitting element;
a first transistor comprising a control electrode connected to a first node, a first electrode connected to a second node, and a second electrode connected to an anode electrode of the light emitting element;
a second transistor comprising a control electrode configured to receive the first gate signal, a first electrode configured to receive the data voltage, and a second electrode connected to the second node;
a third transistor comprising a control electrode configured to receive the second gate signal, a first electrode connected to the first node, and a second electrode connected to the anode electrode of the light emitting element; and
a fourth transistor comprising a control electrode configured to receive the emission signal, a first electrode configured to receive a first power voltage, and a second electrode connected to the second node.
